(19) United States
(12) Patent Application Publication
(10) Pub. No.: US 2026/0155599 A1
(43) Pub. Date: Jun. 4, 2026

(54) CONNECTOR

(71) Applicant: Yazaki Corporation, Tokyo (JP)

(72) Inventors: Motohide Sato, Makinohara-shi (JP); Takashi Ishihara, Makinohara-shi (JP)

(21) Appl. No.: 19/406,095

(22) Filed: Dec. 2, 2025

(30) Foreign Application Priority Data
Dec. 3, 2024 (JP) 2024-209892

(51) Int. Cl. H01R 13/502

(52) U.S. Cl. CPC H01R 13/502; H01R 2201/26

(57) ABSTRACT

A connector includes: an electric wire; a first component housing the electric wire; and a second component attached to the first component so as to face in a second direction, the second direction intersecting a first direction in which the electric wire extends. The first component includes: an electric wire housing portion that houses the electric wire so as to surround an outer peripheral surface of the electric wire and opens toward the second component; and a first approaching portion continuous with the electric wire housing portion in a third direction, the third direction intersecting with both the first direction and the second direction. The second component includes: a regulating portion disposed so as to face the electric wire housing portion in the second direction and configured to regulate movement of the electric wire in the second direction; and a second approaching portion continuous with the regulating portion.

### BACKGROUND OF THE INVENTION

### Field of the Invention

The embodiments of the present invention relate to a connector.

Priority is claimed on Japanese Patent Application No. 2024-209892 filed in Japan on Dec. 3, 2024, the content of which is incorporated herein by reference.

### Description of Related Art

Patent Document 1(Japanese Unexamined Patent Application, First Publication No. 2024-41315) discloses a connector for electrically connecting vehicle devices to each other. The connector includes a connector housing, an electric wire, and a back retainer. The electric wire is drawn out from the connector housing. The back retainer is assembled to the connector housing. The back retainer has a pair of divided retainers. The pair of divided retainers sandwiches and holds the electric wire from a vertical direction of the electric wire, and is fixed to each other.

### PRIOR ART DOCUMENT

### Patent Document

Patent Document 1: Japanese Unexamined Patent Application, First Publication No. 2024-41315

### SUMMARY OF THE INVENTION

However, in the connector of Patent Document 1, in some cases, the coating film of the electric wire is sandwiched between the pair of divided retainers at the time of assembly.

One embodiment is to provide a connector that can be assembled without sandwiching an electric wire.

A connector according to one embodiment includes: an electric wire; a first component housing the electric wire; and a second component attached to the first component so as to face in a second direction, the second direction intersecting a first direction in which the electric wire extends. The first component includes: an electric wire housing portion that houses the electric wire so as to surround an outer peripheral surface of the electric wire and opens toward the second component; and a first approaching portion continuous with the electric wire housing portion in a third direction, the third direction intersecting with both the first direction and the second direction. The second component includes: a regulating portion disposed so as to face the electric wire housing portion in the second direction and configured to regulate movement of the electric wire in the second direction; and a second approaching portion continuous with the regulating portion in the third direction and disposed close to the first approaching portion in the second direction. The first approaching portion is closer to the second component in the second direction than the electric wire. The electric wire housing portion is formed deeper in the second direction than a diameter of the electric wire.

According to one embodiment, a connector can be assembled without sandwiching an electric wire.

### BRIEF DESCRIPTION OF THE DRAWINGS

FIG. 1 is a perspective view of a connector according to an embodiment.

FIG. 2 is a plan view of the connector according to the embodiment.

FIG. 3 is a cross-sectional view taken along a line F3-F3 of FIG. 2.

FIG. 4 is a view illustrating an electronic housing portion and a regulating portion according to the embodiment.

FIG. 5 is an enlarged view of a part F5 in FIG. 3.

FIG. 6 is an enlarged cross-sectional view illustrating the electronic housing portion and the regulating portion according to the embodiment.

### DETAILED DESCRIPTION OF THE INVENTION

Hereinafter, embodiments will be described with reference to the drawings. In the following description, constitutions having the same or similar functions are denoted by the same reference signs. Redundant descriptions of these constitutions may be omitted. The constitution described below does not limit the scope of the embodiments.

In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. The term “housing” is not limited to a case where the entire component is housed, and may include a case where only a part of the component is housed (a state in which the remaining part of the component protrudes). The term “facing” indicates that virtual projection images of two target objects overlap each other when viewed from a specific direction. That is, the term “facing” is not limited to a case where two target objects directly face each other, and may include a case where two target objects face each other in a state where another member exists between the two target objects. “Parallel”, “perpendicular”, or “the same” may include “substantially parallel”, “substantially perpendicular”, or “substantially the same”, respectively.

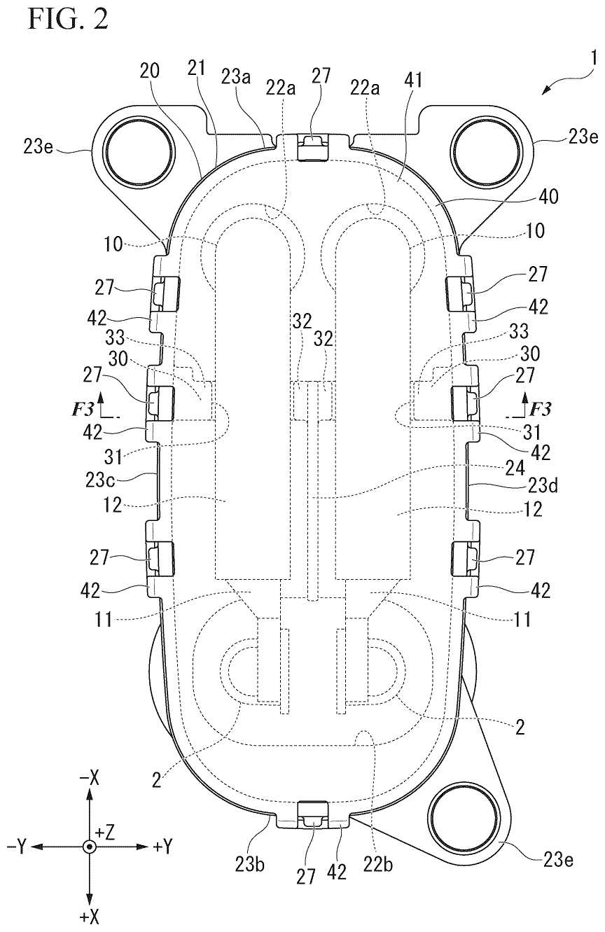

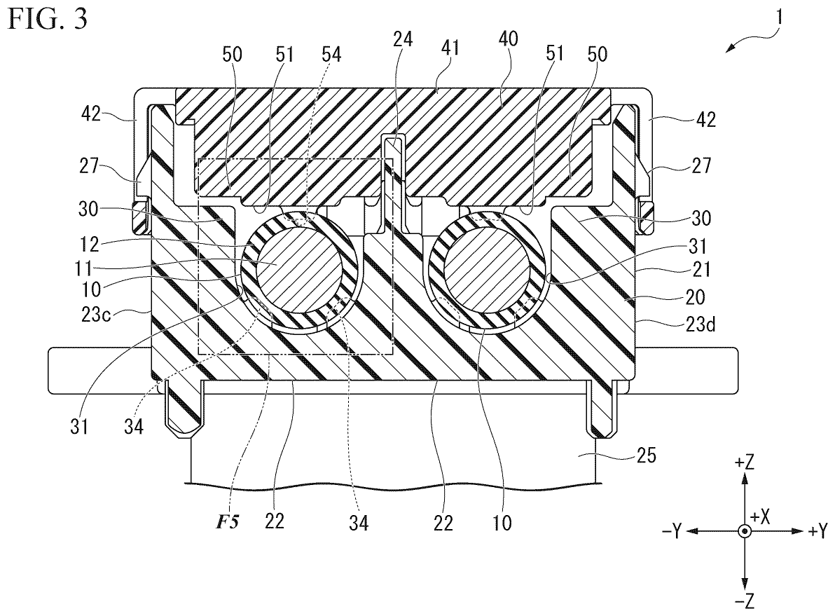

In the present disclosure, a +X direction, a −X direction, a +Y direction, a −Y direction, a +Z direction, and a −Z direction are defined as follows. The +X direction is a direction from a lead-out portion 25 of a housing 20 to be described later toward a terminal housing portion 26 (see FIG. 2). The −X direction is a direction opposite to the +X direction. Hereinafter, in a case where the +X direction and the −X direction are not distinguished, the directions will be simply referred to as “X direction”. The +Y direction and the −Y direction are directions intersecting with (for example, perpendicular to) the X direction. The +Y direction is a direction from a third side wall 23c to a fourth side wall 23d of the housing main body 21 to be described later (see FIG. 2). The −Y direction is a direction opposite to the +Y direction. Hereinafter, in a case where the +Y direction and the −Y direction are not distinguished, the directions will be simply referred to as “Y direction”. The +Z direction and the −Z direction are directions intersecting with (for example, perpendicular to) the X direction and the Y direction. The +Z direction is a direction from the housing 20 to be described later toward a cover 40 (see FIG. 3). The −Z direction is a direction opposite to the +Z direction. Hereinafter, in a case where the +Z direction and the −Z direction are not distinguished, the directions will be simply referred to as “Z direction”.

Hereinafter, in a case where the X direction and the Y direction are not distinguished, the directions may be referred to as “horizontal direction”. In addition, hereinafter, the present embodiment will be described with an example in which the X direction is the “front-rear direction”, the Y direction is the “right-left direction”, and the Z direction is the “up-down direction”. Hereinafter, the +Z direction side is referred to as an “upper side”, and the −Z direction side is referred to as a “lower side”. However, these expressions do not limit the gravity direction of a connector 1 (the installation posture of the connector 1). Note that the X direction is an example of a “first direction”, the Y direction is an example of a “third direction”, and the Z direction is an example of a “second direction”.

### 1. Constitution of Connector

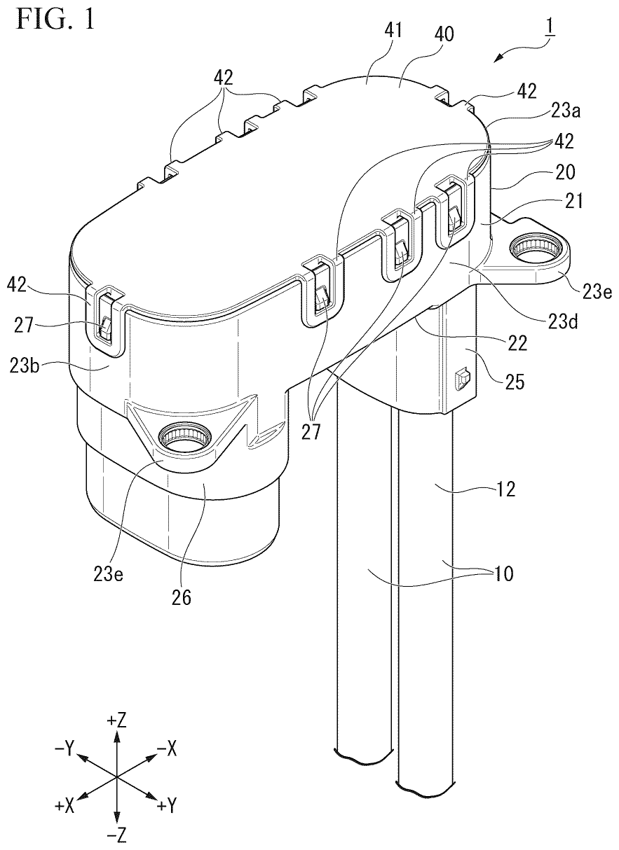

FIG. 1 is a perspective view illustrating the connector 1 of the present embodiment. FIG. 2 is a plan view of the connector 1 of the present embodiment. The connector 1 is a connection component for electrically connecting a terminal portion 2 provided at the end portion of an electric wire 10 and a fitting portion (not illustrated) of the other portion. The connector 1 is, for example, a connector 1 used for a vehicle such as an electric vehicle (EV), a hybrid electric vehicle (HEV), or a plug-in hybrid electric vehicle (PHEV). As illustrated in FIGS. 1 and 2, the connector 1 according to the present embodiment includes the electric wire 10, a terminal portion 2, the housing 20 (first component), and a cover 40 (second component). The connector 1 of the present embodiment has a structure that houses the electric wire 10 therein and suppresses propagation of an external force transmitted to the electric wire 10. Hereinafter, the structure of the connector 1 will be described in detail.

### 2. Electric Wire

As illustrated in FIG. 2, a plurality of (two in the illustrated example) electric wires 10 is provided. Each electric wire 10 is a coated electric wire. The electric wire 10 includes a core wire 11 that is a conductor and a coating film 12 made of resin that coats the core wire 11 over substantially the entire length (see FIG. 3). The insulation sheath is peeled off at the end portion of each electric wire 10 to expose the core wire 11.

### 3. Terminal Portion

The terminal portion 2 is provided at the end portion of the exposed core wire 11 of each electric wire 10. The terminal portion 2 is formed of a conductive material such as metal. For example, the terminal portion 2 is formed into a predetermined shape by bending a metal plate as a base material or press molding such as cutting. In the illustrated example, the terminal portion 2 is provided at an end portion of the electric wire 10 on the +X direction side.

### 4. Housing

The housing 20 is a component that houses the electric wire 10. The housing 20 includes a housing main body 21, a partition wall 24, a lead-out portion 25, a first engagement portion 27, and a first holding portion 30.

### Housing Main Body

The housing main body 21 is formed to extend in the X direction. The housing main body 21 opens toward the +Z direction. The housing main body 21 includes a bottom wall 22, a first side wall 23a, a second side wall 23b, a third side wall 23c, a fourth side wall 23d, and a mounting flange 23e. The bottom wall 22 extends in the horizontal direction. The bottom wall 22 is formed in a flat plate shape elongated in the X direction. A first lead-out hole 22a penetrating in the Z direction is formed at an end portion on the −X direction side of the bottom wall 22. Two first lead-out holes 22a are formed in parallel in the Y direction. From each of the first lead-out holes 22a, the electric wire 10 is drawn out in the −Z direction. A second lead-out hole 22b penetrating in the Z direction is formed at an end portion on the +X direction side of the bottom wall 22. From the second lead-out hole 22b, a terminal of each electric wire 10 is drawn out in the −Z direction. The first side wall 23a is provided at an end edge on the −X direction side of the bottom wall 22. The first side wall 23a protrudes from the bottom wall 22 in the +Z direction. The second side wall 23b is provided at an end edge on the +X direction side of the bottom wall 22. The second side wall 23b protrudes from the bottom wall 22 in the +Z direction. The third side wall 23c is provided at an end edge on the-Y direction side of the bottom wall 22. The third side wall 23c protrudes from the bottom wall 22 in the +Z direction. The third side wall 23c connects the first side wall 23a and the second side wall 23b in the X direction. The fourth side wall 23d is provided at an end edge on the +Y direction side of the bottom wall 22. The fourth side wall 23d protrudes from the bottom wall 22 in the +Z direction. The fourth side wall 23d connects the first side wall 23a and the second side wall 23b in the X direction. An end edge on the +Z direction side of each side wall (first side wall 23a, second side wall 23b, third side wall 23c, and fourth side wall 23d) forms an opening of the housing main body 21. The mounting flange 23e is a member for mounting the housing 20 to a vehicle body. The mounting flange 23e is formed so as to protrude in the horizontal direction from the housing main body 21. In the illustrated example, the mounting flange 23e is provided at each of a boundary portion between the first side wall 23a and the third side wall 23c, a boundary portion between the first side wall 23a and the fourth side wall 23d, and a boundary portion between the second side wall 23b and the fourth side wall 23d.

Two electric wires 10 are housed in the housing main body 21 so as to extend in the X direction. The two electric wires 10 are arranged in parallel in the Y direction. Each of the electric wires 10 is drawn out in the −Z direction from the first lead-out hole 22a. In addition, a terminal of each electric wire 10 is drawn out in the −Z direction from the second lead-out hole 22b. Hereinafter, a direction in which a portion of the electric wire 10 extending in the X direction in the housing main body 21 extends will be described as an extending direction of the electric wire 10. That is, the extending direction of the electric wire 10 means the X direction.

### Partition Wall

The partition wall 24 is provided inside the housing main body 21 at a center portion of the housing main body 21 in the Y direction. The partition wall 24 protrudes in the +Z direction from the bottom wall 22 and extends in the X direction from the first holding portion 30 to be described later to a position in front of the second lead-out hole 22b. The partition wall 24 partitions the inside of the housing main body 21 in the Y direction. One electric wire 10 is housed in each space partitioned by the partition wall 24.

### Lead-Out Portion

The lead-out portion 25 is provided at an end portion on the −X direction side of the housing 20. The lead-out portion 25 protrudes in the −Z direction from the bottom wall 22 of the housing main body 21. The lead-out portion 25 is formed in a tubular shape extending in the −Z direction. The lead-out portion 25 communicates with two first lead-out holes 22a formed in the housing main body 21. From the lead-out portion 25, each electric wire 10 is drawn out in the −Z direction.

### Terminal Housing Portion

The terminal housing portion 26 is provided at an end portion on the +X direction side of the housing 20. The terminal housing portion 26 protrudes in the −Z direction from the bottom wall 22 of the housing main body 21. The terminal housing portion 26 is formed in a tubular shape extending in the −Z direction. The terminal housing portion 26 communicates with the second lead-out hole 22b formed in the housing main body 21. The terminal portion 2 of each electric wire 10 drawn out from the housing main body 21 in the −Z direction is housed in the terminal housing portion 26.

### First Engagement Portion

The first engagement portion 27 is provided near the opening of the housing main body 21. The first engagement portion 27 is a portion that engages with the cover 40 to be described later. The first engagement portion 27 is provided at an end edge on the +Z direction side of the first side wall 23a, the second side wall 23b, the third side wall 23c, and the fourth side wall 23d. Specifically, one first engagement portion 27 is provided on each of the first side wall 23a and the second side wall 23b. In addition, a plurality of (three in the illustrated example) first engagement portions 27 is provided on each of the third side wall 23c and the fourth side wall 23d.

### First Holding Portion

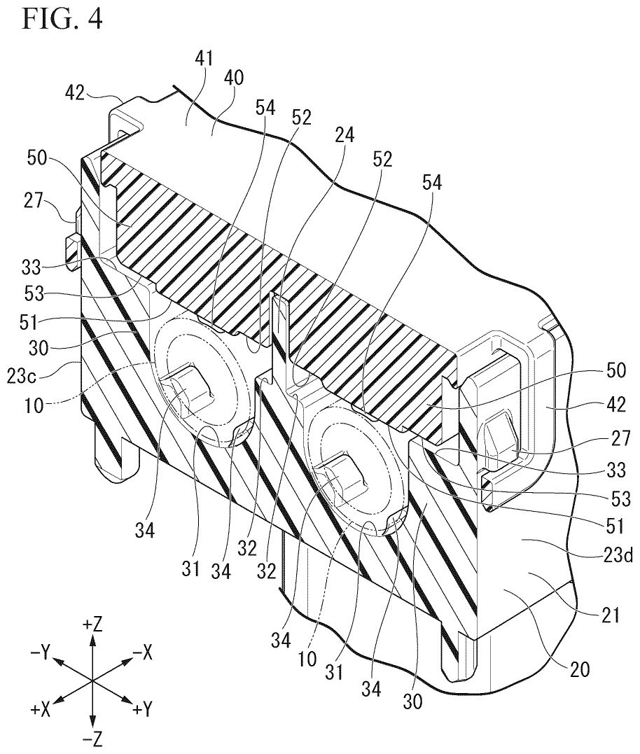

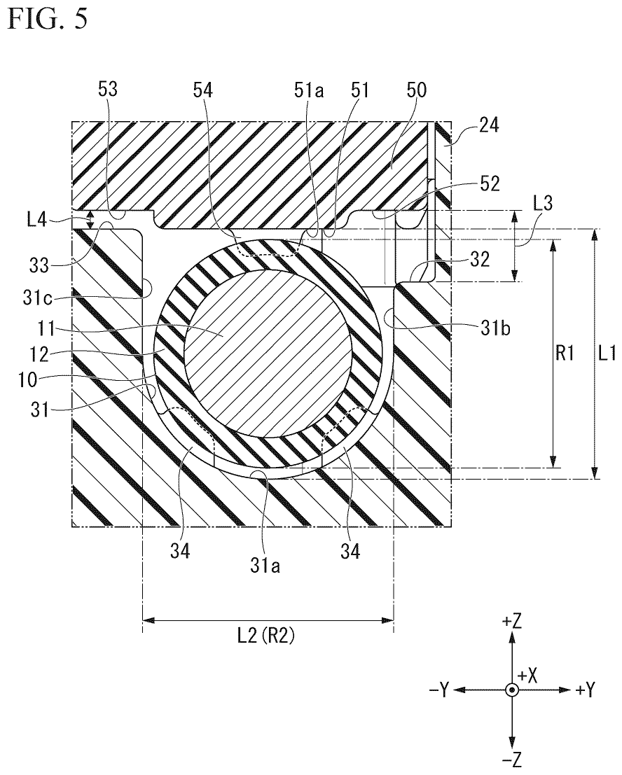

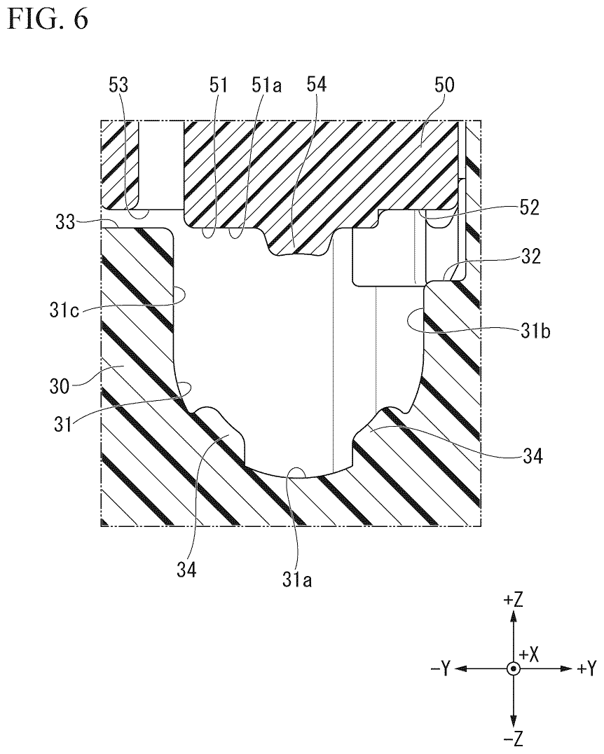

The first holding portion 30 is a member that holds the electric wire 10 together with a second holding portion 50 to be described later. The first holding portion 30 is provided inside the housing main body 21. The first holding portion 30 is positioned between the first lead-out hole 22a and the second lead-out hole 22b in the X direction. The first holding portions 30 are formed one by one on both sides in the Y direction with sandwiching the partition wall 24 therebetween. The first holding portion 30 protrudes from the bottom wall 22 in the +Z direction and connects the partition wall 24 and the third side wall 23c or the fourth side wall 23d in the Y direction. As illustrated in FIGS. 3 to 6, the first holding portion 30 includes the terminal housing portion 26, a first approaching portion 33, and a first pressing portion 34. FIG. 3 is a cross-sectional view taken along a line F3-F3 of FIG. 2. FIG. 4 is a view illustrating an electronic housing portion and a regulating portion according to the present embodiment. FIG. 5 is an enlarged view of a part F5 in FIG. 3. In addition, FIG. 6 is an enlarged view illustrating an electric wire housing portion 31 and a regulating portion 51 of the present embodiment.

(Electric wire housing portion)

The electric wire housing portion 31 is a groove that penetrates the first holding portion 30 in the X direction and opens in the +Z direction. That is, the electric wire housing portion 31 opens toward the cover 40 to be described later. The electric wire 10 is housed in the electric wire housing portion 31 from the +Z direction side. The electric wire housing portion 31 surrounds the outer peripheral surface of the electric wire 10. The electric wire housing portion 31 is formed deeper in the Z direction than a diameter R1 of the electric wire 10. That is, a depth L1 of the electric wire housing portion 31 in the Z direction is larger than the diameter R1 of the electric wire 10. In addition, the electric wire housing portion 31 is formed to be wider in the Y direction than the diameter R1 of the electric wire 10. That is, a width L2 of the electric wire housing portion 31 in the Y direction is larger than the diameter R1 of the electric wire 10. The electric wire housing portion 31 includes a curved surface portion 31a, a first flat surface portion 31b, and a second flat surface portion 31c. The curved surface portion 31a is disposed on the −Z direction side with respect to the electric wire 10 and supports the electric wire 10 from the −Z direction. The curved surface portion 31a is formed in a curved surface shape along the outer peripheral surface of the electric wire 10. A diameter R2 of the curved surface portion 31a is larger than the diameter R1 of the electric wire 10. Note that, in the present embodiment, the diameter R2 of the curved surface portion 31a is substantially equal to the width L2 of the electric wire housing portion 31 in the Y direction. The first flat surface portion 31b is provided at an end portion of the curved surface portion 31a on the partition wall 24 side in the Y direction. The first flat surface portion 31b extends in the +Z direction from the curved surface portion 31a. The first flat surface portion 31b is smoothly connected to the curved surface portion 31a. The second flat surface portion 31c is provided at an end portion of the curved surface portion 31a opposite to the partition wall 24 in the Y direction. The second flat surface portion 31c extends in the +Z direction from the curved surface portion 31a. The second flat surface portion 31c is smoothly connected to the curved surface portion 31a. The second flat surface portion 31c is formed to be longer in the Z direction than the first flat surface portion 31b, and is closer to the cover 40 than the first flat surface portion 31b.

### First Escape Portion

A first escape portion 32 is continuous with the first flat surface portion 31b of the electric wire housing portion 31 in the Y direction. The first escape portion 32 extends from the first flat surface portion 31b toward the partition wall 24 side in the Y direction and is connected to the partition wall 24. The first escape portion 32 is a portion facing a second escape portion 52 of the cover 40 to be described later in the Z direction. The first escape portion 32 is provided at a position farther from the second escape portion 52 in the −Z direction than the electric wire 10.

### First Approaching Portion

The first approaching portion 33 is continuous with the second flat surface portion 31c of the electric wire housing portion 31 in the Y direction. The first approaching portion 33 is a portion close to a second approaching portion 53 of the cover 40 to be described later in the Z direction. The first approaching portion 33 is closer to the second approaching portion 53 in the Z direction than the electric wire 10. The first approaching portion 33 extends from the second flat surface portion 31c in a direction away from the partition wall 24 in the Y direction and is connected to the third side wall 23c or the fourth side wall 23d. Note that the first approaching portion 33 and the second approaching portion 53 to be described later constitute a matching portion serving as a reference for positioning the housing 20 and the cover 40 at the time of assembly. The first approaching portion 33 may be referred to as a first matching portion, and the second approaching portion 53 may be referred to as a second matching portion. Note that the first approaching portion 33 and the second approaching portion 53 may or may not be in contact with each other.

### First Pressing Portion

The first pressing portion 34 is provided on the curved surface portion 31a of the electric wire housing portion 31. Two first pressing portions 34 are provided side by side in the Y direction. The first pressing portion 34 protrudes from the curved surface portion 31a toward the electric wire 10 and presses the electric wire 10 in the +Z direction. The first pressing portion 34 sandwiches the electric wire 10 from both sides in the Z direction together with the second pressing portion 54 to be described later to prevent positional displacement of the electric wire 10.

### 5. Cover

As illustrated in FIG. 1, the cover 40 is attached so as to face the housing 20 in the Z direction. The cover 40 covers the opening of the housing 20 from the +Z direction. The cover 40 prevents the inside of the housing 20 from being exposed. The cover 40 includes a cover main body 41, a second engagement portion 42, and the second holding portion 50 (see FIG. 3).

### Cover Main Body

As illustrated in FIG. 2, a cover main body 41 is formed in a flat plate shape elongated in the X direction. The cover main body 41 has the same shape as the opening edge of the housing main body 21 and is formed to be slightly larger than the opening edge of the housing main body 21. The cover main body 41 covers the entire opening of the housing main body 21.

### Second Engagement Portion

The second engagement portion 42 is a portion that engages with the first engagement portion 27 of the housing 20 described above. The second engagement portion 42 is provided on an outer peripheral edge of the cover main body 41. Specifically, one second engagement portion 42 is provided at each end edge of the cover main body 41 on both sides in the X direction. In addition, a plurality of (in the illustrated example, three) second engagement portions 42 is provided at both end edges of the cover main body 41 in the Y direction. The cover 40 is attached to the housing 20 by engaging the second engagement portion 42 with the first engagement portion 27.

### Second Holding Portion

The second holding portion 50 is a member that holds the electric wire 10 together with the first holding portion 30 described above. As illustrated in FIGS. 3 and 4, the second holding portion 50 is provided on the −Z direction-side surface of the cover main body 41. The second holding portions 50 are disposed one by one on both sides in the Y direction with sandwiching the partition wall 24 therebetween. The second holding portion 50 is provided so as to protrude from the cover main body 41 in the −Z direction. Each of the second holding portions 50 faces the corresponding first holding portion 30 in the Z direction. The second holding portion 50 includes the regulating portion 51, the second escape portion 52, and the second approaching portion 53.

### Regulating Portion

The regulating portion 51 is disposed so as to face the electric wire housing portion 31 in the Z direction, and regulates (restricts) the movement of the electric wire 10 in the Z direction. The regulating portion 51 protrudes in the −Z direction and extends in the Y direction. A regulating surface 51a on the −Z direction side of the regulating portion 51 is formed in a planar shape extending in the Y direction. The regulating portion 51 is formed to be slightly narrower in the Y direction than the diameter R1 of the electric wire 10. That is, the width of the regulating portion 51 in the Y direction is slightly smaller than the diameter R1 of the electric wire 10.

### Second Escape Portion

The second escape portion 52 is continuous with an end portion of the regulating portion 51 on the partition wall 24 side in the Y direction. The second escape portion 52 extends from the regulating portion 51 toward the partition wall 24 side in the Y direction and is connected to the partition wall 24. The second escape portion 52 is a portion facing the first escape portion 32 of the housing 20 described above in the Z direction. A distance L3 in the Z direction between the second escape portion 52 and the first escape portion 32 is longer than a distance L4 in the Z direction between the second approaching portion 53 and the first approaching portion 33 to be described later.

### Second Approaching Portion

The second approaching portion 53 is continuous with an end portion of the regulating portion 51 opposite to the partition wall 24 in the Y direction. The second approaching portion 53 is a portion close to the first approaching portion 33 of the housing 20 described above in the Z direction. The first approaching portion 33 is closer to the second approaching portion 53 in the Z direction than the electric wire 10. The second approaching portion 53 extends from the regulating portion 51 in a direction away from the partition wall 24 in the Y direction. The second approaching portion 53 is disposed farther from the electric wire housing portion 31 in the Z direction than the regulating portion 51. In addition, the second approaching portion 53 is provided at substantially the same position as the second escape portion 52 in the Z direction.

### Second Pressing Portion

The second pressing portion 54 is provided at the center portion of the regulating portion 51 in the Y direction. The second pressing portion 54 protrudes from the regulating surface 51a of the regulating portion 51 toward the electric wire 10 and presses the electric wire 10 in the −Z direction. The second pressing portion 54 is disposed at the center of the two first pressing portions 34 in the Y direction. The second pressing portion 54 sandwiches the electric wire 10 from both sides in the Z direction together with the above-described first pressing portion 34 to prevent positional displacement of the electric wire 10.

### 6. Advantages

Here, in a connector having a structure of suppressing propagation of an external force transmitted to an electric wire, it has been a problem that a coating film of the electric wire is caught at a matching portion between components for suppressing the external force propagation, and insulation performance is impaired.

In order to solve this problem, in the present embodiment, the connector 1 includes the electric wire 10, the housing 20, and the cover 40. The housing 20 is a member that houses the electric wire 10. The cover 40 is attached so as to face the housing 20 in the Z direction intersecting the X direction in which the electric wire 10 extends. The housing 20 includes the electric wire housing portion 31 and the first approaching portion 33. The electric wire housing portion 31 houses the electric wire 10 so as to surround the outer peripheral surface of the electric wire 10, and opens toward the cover 40. The first approaching portion 33 is continuous with the electric wire housing portion 31 in the Y direction intersecting both the X direction and the Z direction. The cover 40 includes the regulating portion 51 and the second approaching portion 53. The regulating portion 51 is a member that is disposed so as to face the electric wire housing portion 31 in the Z direction, and regulates the movement of the electric wire 10 in the Z direction. The second approaching portion 53 is continuous with the regulating portion 51 in the Y direction, and is disposed close to the first approaching portion 33 in the Z direction. The first approaching portion 33 is closer to the cover 40 in the Z direction than the electric wire 10, and the electric wire housing portion 31 is formed deeper in the Z direction than the diameter R1 of the electric wire 10.

According to such a constitution, since the electric wire 10 can be stably held by the cover 40 and the housing 20, the propagation of the external force transmitted to the electric wire 10 is suppressed. In addition, since the electric wire housing portion 31 is formed deeper in the Z direction than the diameter R1 of the electric wire 10, the electric wire 10 can be placed on the housing 20 so as to prevent the electric wire 10 from jumping out from the electric wire housing portion 31 at the time of assembling the electric wire 10. Since the electric wire 10 is disposed in this manner, the connector 1 can be assembled without sandwiching the electric wire 10 between the first approaching portion 33 and the second approaching portion 53. Since the coating film of the electric wire 10 can be prevented from being caught by the first approaching portion 33 and the second approaching portion 53, the insulation performance is more reliably ensured.

In the present embodiment, the second approaching portion 53 is disposed farther from the electric wire housing portion 31 in the Z direction than the regulating portion 51.

According to such a constitution, the electric wire 10 is more reliably prevented from being sandwiched by the first approaching portion 33 and the second approaching portion 53.

In the present embodiment, the electric wire housing portion 31 is formed to be wider in the Y direction than the diameter R1 of the electric wire 10.

According to such a constitution, the electric wire 10 is prevented from being crushed from both sides in the Y direction by the electric wire housing portion 31 and protruding to the outside of the electric wire housing portion 31, and thus the electric wire 10 is more reliably prevented from being sandwiched by the first approaching portion 33 and the second approaching portion 53.

In the present embodiment, the housing 20 includes the first pressing portion 34 protruding from the electric wire housing portion 31 toward the electric wire 10. The cover 40 includes the second pressing portion 54 that protrudes from the regulating portion 51 toward the electric wire 10 and sandwiches the electric wire 10 from both sides in the Z direction together with the first pressing portion 34.

According to such a constitution, the electric wire 10 can be stably held. Therefore, the propagation of the external force transmitted to the electric wire 10 is reliably suppressed.

Several embodiments and modification examples have been described above. However, the embodiments and the modification examples are not limited to the examples described above. For example, a plurality of embodiments may be implemented in combination with each other.

### Industrial Applicability

According to one embodiment, a connector can be assembled without sandwiching an electric wire.

### REFERENCE SIGNS LIST

1 Connector
2 Terminal portion
10 Electric wire
11 Core wire
12 Coating film
20 Housing (first component)
21 Housing main body
22 Bottom wall
22a First lead-out hole
22b Second lead-out hole
23a First side wall
23b Second side wall
23c Third side wall
23d Fourth side wall
23e Mounting flange
24 Partition wall
25 Lead-out portion
26 Terminal housing portion
27 First engagement portion
30 First holding portion
31 Electric wire housing portion
31a Curved surface portion
31b First flat surface portion
31c Second flat surface portion
32 First escape portion
33 First approaching portion
34 First pressing portion
40 Cover (second component)
41 Cover main body
42 Second engagement portion
50 Second holding portion
51 Regulating portion
51a Regulating surface
52 Second escape portion
53 Second approaching portion
54 Second pressing portion
L1 Depth
L2 Width
L3 Distance
L4 Distance
R1 Diameter
R2 Diameter

What is claimed is:

1. A connector comprising:
an electric wire;
a first component housing the electric wire; and
a second component attached to the first component so as to face in a second direction, the second direction intersecting a first direction in which the electric wire extends,
wherein the first component includes:
an electric wire housing portion that houses the electric wire so as to surround an outer peripheral surface of the electric wire and opens toward the second component; and
a first approaching portion continuous with the electric wire housing portion in a third direction, the third direction intersecting with both the first direction and the second direction,
wherein the second component includes:
a regulating portion disposed so as to face the electric wire housing portion in the second direction and configured to regulate movement of the electric wire in the second direction; and
a second approaching portion continuous with the regulating portion in the third direction and disposed close to the first approaching portion in the second direction,
wherein the first approaching portion is closer to the second component in the second direction than the electric wire, and
wherein the electric wire housing portion is formed deeper in the second direction than a diameter of the electric wire.

2. The connector according to claim 1,
wherein the second approaching portion is disposed farther from the electric wire housing portion in the second direction than the regulating portion.

3. The connector according to claim 1,
wherein the electric wire housing portion is formed to be wider in the third direction than a diameter of the electric wire.

4. The connector according to claim 1,
wherein the first component includes a first pressing portion protruding from the electric wire housing portion toward the electric wire, and
wherein the second component includes a second pressing portion protruding from the regulating portion toward the electric wire, and the first pressing portion and the second pressing portion sandwich the electric wire from both sides in the second direction.
